(19) United States
(12) Patent Application Publication
(10) Pub. No.: US 2026/0133454 A1
(43) Pub. Date: May 14, 2026

(54) INTELLIGENT REFLECTING SURFACE

(71) Applicant: Japan Display Inc., Tokyo (JP)

(72) Inventors: Daiichi SUZUKI, Tokyo (JP); Shinichiro OKA, Tokyo (JP); Mitsutaka OKITA, Tokyo (JP); Kazuki MATSUNAGA, Tokyo (JP)

(73) Assignee: Japan Display Inc., Tokyo (JP)

(21) Appl. No.: 19/444,252

(22) Filed: Jan. 9, 2026

Related U.S. Application Data
(63) Continuation of application No. PCT/JP2024/024545, filed on Jul. 8, 2024.

(30) Foreign Application Priority Data
Aug. 8, 2023 (JP) 2023-129155

(51) Int. Cl. G02F 1/1337; G02F 1/1343

(52) U.S. Cl. CPC G02F 1/133707; G02F 1/134318

(57) ABSTRACT

An intelligent reflecting surface includes a plurality of reflecting elements arranged in a matrix form having a plurality of rows and a plurality of columns. The plurality of reflecting elements each has a patch electrode, a first orientation film over the patch electrode, a liquid crystal layer over the first orientation film, a second orientation film over the liquid crystal layer, and a common electrode over the second orientation film. The patch electrode has a plurality of first slits parallel to one another, having the same width, and extending in one of a row direction and a column direction. The common electrode has a plurality of second slits parallel to the first slits and having the same width as the first slits. In each of the plurality of reflecting elements, a distance between adjacent first slits is constant and the same as a distance between adjacent second slits.

### CROSS-REFERENCE TO RELATED APPLICATIONS

This application is a Continuation of International Patent Application No. PCT/JP2024/024545, filed on Jul. 8, 2024, which claims the benefit of priority to Japanese Patent Application No. 2023-129155, filed on Aug. 8, 2023, the entire contents of each are incorporated herein by reference.

### FIELD

An embodiment of the present invention relates to an intelligent reflecting surface.

### BACKGROUND

Since liquid crystal molecules have an anisotropic dielectric constant, the dielectric constant of a liquid crystal layer can be controlled by adjusting an electric field applied to the liquid crystal layer containing liquid crystal molecules to control the orientation of the liquid crystal molecules. Metasurfaces capable of controlling reflectance characteristics of liquid crystal layers with respect to radio waves by utilizing such characteristics have been known (see, for example, Japanese Patent Application Publications No. H11-103201 and 2019-530387).

### SUMMARY

An embodiment of the present invention is an intelligent reflecting surface. The intelligent reflecting surface includes a plurality of reflecting elements arranged in a matrix form having a plurality of rows and a plurality of columns. Each of the plurality of reflecting elements includes a patch electrode, a first orientation film over the patch electrode, a liquid crystal layer over the first orientation film, a second orientation film over the liquid crystal layer, and a common electrode over the second orientation film. The patch electrode has a plurality of first slits, and the plurality of first slits is parallel to one another, has the same width, and extends in one of a row direction and a column direction. The common electrode has a plurality of second slits, and the plurality of second slits is parallel to the plurality of first slits and has the same width as the plurality of first slits. In each of the plurality of reflecting elements, a distance between adjacent first slits is constant and the same as a distance between adjacent second slits.

### BRIEF DESCRIPTION OF DRAWINGS

FIG. 1 is a schematic developed perspective view of an intelligent reflecting surface according to an embodiment of the present invention.

FIG. 2 is a schematic top view of an intelligent reflecting surface according to an embodiment of the present invention.

FIG. 3A is a schematic plan view of a counter substrate of an intelligent reflecting surface according to an embodiment of the present invention.

FIG. 3B is a schematic plan view of a counter substrate of an intelligent reflecting surface according to an embodiment of the present invention.

FIG. 4 is a schematic plan view of a patch electrode of a reflecting element according to an embodiment of the present invention.

FIG. 5 is a schematic plan view of a common electrode of a reflecting element according to an embodiment of the present invention.

FIG. 6 is a schematic cross-sectional view of a reflecting element of an intelligent reflecting surface according to an embodiment of the present invention.

FIG. 7A is a schematic cross-sectional view showing an arrangement of a patch electrode and a common electrode of an intelligent reflecting surface according to an embodiment of the present invention.

FIG. 7B is a schematic cross-sectional view showing an arrangement of a patch electrode and a common electrode of an intelligent reflecting surface according to an embodiment of the present invention.

FIG. 7C is a schematic cross-sectional view showing an arrangement of a patch electrode and a common electrode of an intelligent reflecting surface according to an embodiment of the present invention.

FIG. 8A is a schematic view showing an operation of an intelligent reflecting surface according to an embodiment of the present invention.

FIG. 8B is a schematic view showing an operation of an intelligent reflecting surface according to an embodiment of the present invention.

FIG. 9 is a schematic top view of an intelligent reflecting surface according to an embodiment of the present invention.

FIG. 10 is a schematic cross-sectional view of a reflecting element of an intelligent reflecting surface according to an embodiment of the present invention.

FIG. 11A includes schematic top and cross-sectional views of a model element 1 evaluated in the Example.

FIG. 11B includes schematic top and cross-sectional views of model elements 2 to 4 evaluated in the Example.

FIG. 12 is a simulation result in the Example.

### DESCRIPTION OF EMBODIMENTS

Hereinafter, each embodiment of the present invention is explained with reference to the drawings. The invention can be implemented in a variety of different modes within its concept and should not be interpreted only within the disclosure of the embodiments exemplified below.

The drawings may be illustrated so that the width, thickness, shape, and the like are illustrated more schematically compared with those of the actual modes in order to provide a clearer explanation. However, they are only an example, and do not limit the interpretation of the invention. In the specification and the drawings, the same reference number is provided to an element that is the same as that which appears in preceding drawings, and a detailed explanation may be omitted.

In the specification and the claims, unless specifically stated, when a state is expressed where a structure is arranged “over” another structure, such an expression includes both a case where a structure is arranged immediately above the “other structure” so as to be in contact with the “other structure” and a case where the structure is arranged over the “other structure” with an additional structure therebetween.

In the specification and the claims, an expression that two structures are “parallel” includes a state where the extending directions of these two structures are at an angle of 0° and do not interest each other as well as a state where the angle between the extending directions thereof is within ±10°

### 1. STRUCTURE OF INTELLIGENT REFLECTING SURFACE

Hereinafter, a structure of an intelligent reflecting surface according to an embodiment of the present invention is explained. This intelligent reflecting surface is a so-called liquid-crystal metasurface reflector and is a device which utilizes the dielectric constant change caused by the orientation change of the liquid crystal layer due to an electric field to reflect applied radio waves in arbitrary directions. There are no restrictions on the frequency of the radio waves which can be reflected, and the frequency is, for example, in the range of 400 MHz to 50 GHz. Typically, this intelligent reflecting surface can be used to reflect radio waves in the 400 MHz to 6.0 GHz band, 2.5 GHz to 4.7 GHz band, and 24 GHZ to 50 GHz band.

### (1) Overall Structure

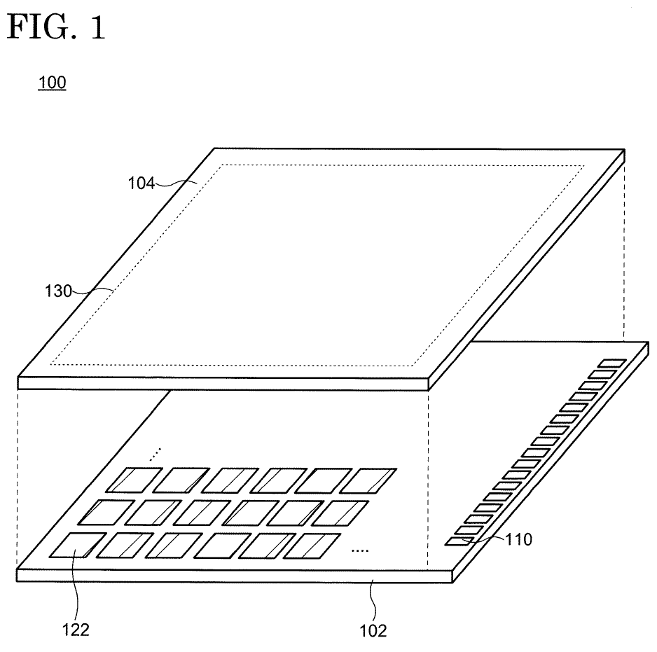

FIG. 1 shows a schematic developed perspective view of the intelligent reflecting surface 100. The intelligent reflecting surface 100 has a substrate 102 and a counter substrate 104 facing each other, between which a variety of patterned insulating films, semiconductor films, and conductive films is fabricated. A plurality of reflecting elements arranged in a matrix form having a plurality of rows and a plurality of columns and the like in addition to a variety of wirings are fabricated by appropriately stacking these films. As described in detail below, each reflecting element includes, as its basic components, a patch electrode 122, a common electrode 130, a liquid crystal layer disposed therebetween, and the like. Wirings (not illustrated) extend over the substrate 102 from the reflecting elements and are exposed at an edge portion of the substrate 102 to form terminals 110. Power and a variety of signals are supplied from an external circuit (not illustrated) via the terminals 110, and the reflecting elements are controlled on the basis of these signals. Radio waves are incident from the substrate 102 side, reflected by the reflecting elements, and emitted toward the substrate 102 side.

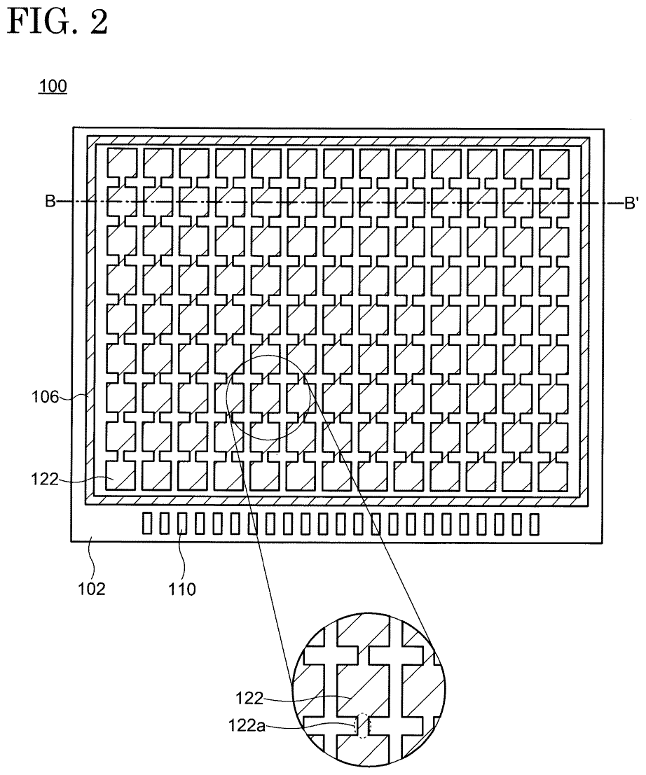

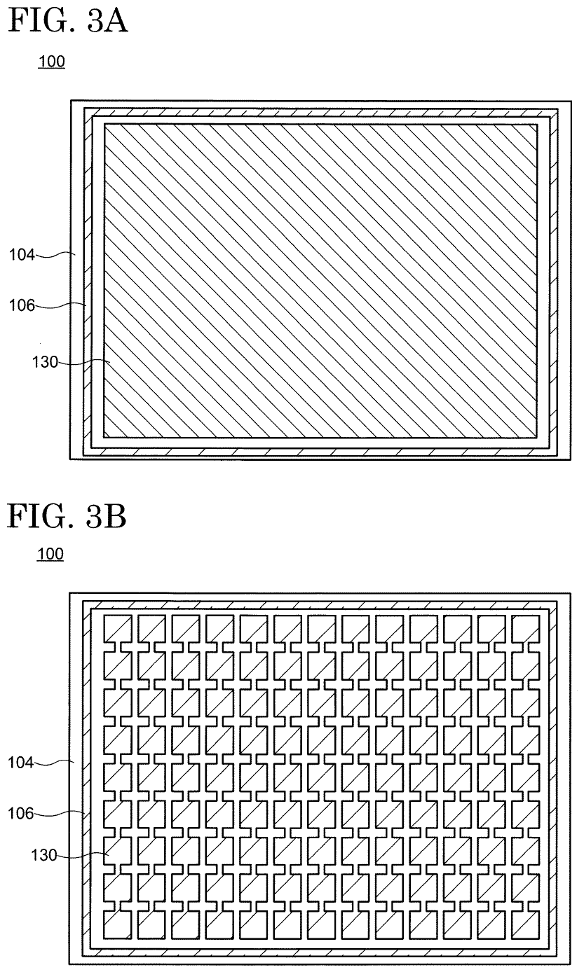

FIG. 2 to FIG. 3B show a schematic top view and plan views of the intelligent reflecting surface 100. FIG. 2 is a schematic top view of the intelligent reflecting surface 100 with the counter substrate 104 removed, while FIG. 3A and FIG. 3B are schematic plan views including the counter substrate 104 viewed from the substrate 102 side. As shown in FIG. 2, a plurality of patch electrodes 122 arranged in a matrix form with a plurality of rows and a plurality of columns is formed over the substrate 102. In order to efficiently reflect both the vertical polarization component and the horizontal polarization component of the incident radio waves, each patch electrode 122 preferably has two symmetrical axes respectively parallel to the row direction and the column direction. Hence, the shape of each patch electrode 122 is preferred to be a regular n polygon (n is an integer equal to or greater than 4) such as a square or a circle and is particularly preferable to be a square. The plurality of patch electrodes 122 located in the same row or the same column is electrically connected to one another via connection portions 122a and are equipotential. In the example shown in FIG. 1, the plurality of patch electrodes 122 located in each column is electrically connected to one another by the connection portions 122a. The potential of the plurality of patch electrodes 122 is controlled by a signal supplied via the terminals 110. The signal provided to the patch electrodes 122 is a DC voltage signal or a polarity-inverted signal in which DC voltages of different polarities are alternately inverted.

On the other hand, the common electrode 130 may be configured as a single electrode overlapping all of the patch electrodes 122 and shared by all of the reflecting elements 120 as shown in FIG. 3A or may be configured as a plurality of electrodes arranged in a matrix form having a plurality of rows and a plurality of columns so as to overlap respective patch electrodes 122 as shown in FIG. 3B. In the latter case, similar to the patch electrodes 122, the plurality of common electrodes 130 located in the same column may be electrically connected to one another as shown in FIG. 3B, or the plurality of common electrodes 130 located in the same row may be electrically connected to one another although not illustrated. Alternatively, all of the common electrodes may be electrically connected to one another. In either case, unlike the patch electrode 122, the same constant potential is applied to all of the common electrodes 130 via the terminals 110. This potential is a ground potential or a mid-level signal of the aforementioned polarity-inverted signal. When the plurality of common electrodes 130 each opposing the patch electrode 122 is provided (FIG. 3B), the shape of the common electrode 130 is preferably a regular n polygon such as a square or a circle similar to the patch electrodes 122 and is further preferable to have the same shape as the patch electrode.

The substrate 102 and the counter substrate 104 are secured to each other by a sealing material 106, and a liquid crystal layer (described below) sandwiched by a pair of orientation films is provided in the space formed by the substrate 102, the counter substrate 104, and the sealing material 106. One reflecting element 120 is constructed by the pair of patch electrode 122 and counter substrate 104, the pair of orientation films, and the liquid crystal layer between the pair of orientation films. Hereinafter, each component of the reflecting element 120 is described in detail.

### (2) Substrate

The substrate 102 and the counter substrate 104 are provided to provide physical strength to the intelligent reflecting surface 100 and to provide a surface for arranging the reflecting elements 120. The substrate 102 and/or the counter substrate 104 may be flexible. The substrate 102 and the counter substrate 104 include an inorganic insulator such as glass and quartz or a polymer such as a polyimide, a polycarbonate, and a polyester and are configured to transmit visible light.

### (3) Patch Electrode

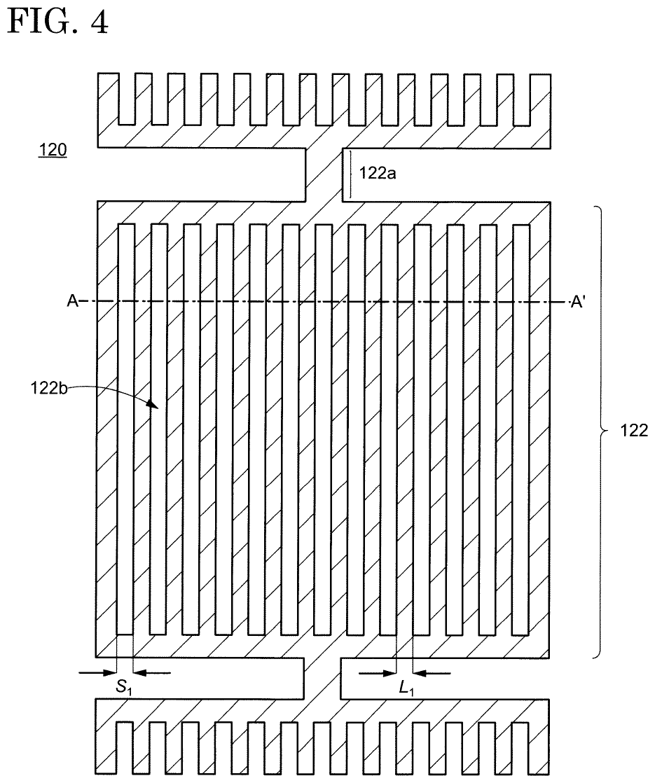

The detailed structure of each patch electrode 122 is explained using the schematic top view in FIG. 4. FIG. 4 shows one patch electrode 122 and a portion of two patch electrodes 122 connected to this patch electrode 122 via the connection portions 122a. As shown in FIG. 4, each patch electrode 122 has a plurality of slits 122b arranged parallel to one another. Here, a slit is an opening formed in a film and having a large aspect ratio, and the contour thereof has a closed shape formed by the film. The direction in which the slit 122b extends may be in the row direction or the column direction or may be inclined from the row direction or the column direction. For example, the direction in which the slit 122b extends may be parallel to the direction in which the plurality of electrically connected patch electrodes 122 extends as shown in FIG. 4 or may be perpendicular thereto although not illustrated. However, the direction in which the slit 122b extends is the same between the patch electrodes 122.

The aspect ratio of each slit 122b, i.e., the length (length in the longitudinal direction) relative to the width (length in the direction perpendicular to the longitudinal direction), may be arbitrarily determined and may be equal to or greater than 3 and equal to or less than 500 or equal to or greater than 10 and equal to or less than 200, for example. The width of the slit 122b is also set to be equal to or greater than 0.1 μm and equal to or less than 100 μm. Furthermore, in each patch electrode 122, the widths of the plurality of slits 122b are the same, and the plurality of slits 122b is arranged at a constant spacing. Therefore, when the width of the slit 122b in each patch electrode 122 is defined as a space width S₁ and the distance between adjacent slits 122b is defined as a line width L₁ (see FIG. 4), the line-space ratio (L₁/S₁), i.e., the ratio of the aforementioned distance to the width of slit 122b, is constant within each patch electrode 122. In addition, L₁/S₁ is the same between the patch electrodes 122. Furthermore, L₁/S₁ is set to be relatively low. Specifically, L₁/S₁ is set to be equal to or greater than 0.05 and equal to or less than 4.0 or equal to or greater than 0.05 and equal to or less than 1.0. Therefore, the space width S₁ may be equal to or greater than the line width L₁. The aperture ratio of each patch electrode 122 can be set in a wide range equal to or greater than 20% and equal to or less than 80% by setting L₁/S₁ in the above range. In other words, it is possible to obtain a high aperture ratio reaching up to 80%. Note that the number of slits 122b provided in each patch electrode 122 may be appropriately set according to the size of the patch electrode 122 and the width of the slit 122b. The number of slits 122b is at least 3 and is preferably equal to or greater than 5 and equal to or less than 200.

The patch electrode 122 may be formed of a conductive oxide such as indium-tin mixed oxide (ITO) and indium-zinc oxide (IZO) or may include a metal (0-valent metal) such as gold, silver, copper, aluminum, molybdenum, tungsten, and titanium or an alloy containing one or a plurality of these metals. The patch electrode 122 may be fabricated by forming a film of a conductive oxide or a metal with a sputtering method or a chemical vapor deposition (CVD) method and subsequentially processing this film by photolithography. When the patch electrode 122 includes a metal, the metal film may be processed so that the portion between adjacent slits 122b has a mesh shape. Alternatively, the patch electrode 122 may be formed using metal nanowires containing silver or gold. It is possible to not only prevent a voltage drop associated with the increase in size of the intelligent reflecting surface 100 but also control the reflection angle of the incident radio waves over a wider range by forming the patch electrode 122 so as to contain a 0-valent metal.

### (4) Common Electrode

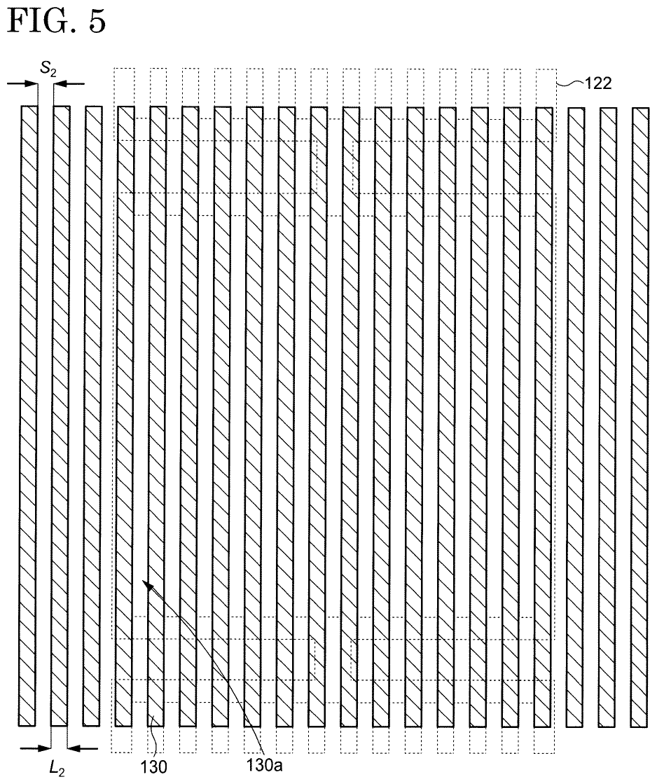

The structure of the common electrode 130 is similar to that of the patch electrode 122. FIG. 5 is a schematic top view of a portion of the common electrode 130 which is formed as a single electrode so as to be shared by all of the reflecting elements 120 and to overlap all of the patch electrodes 122, where the patch electrodes 122 are indicated by dotted lines. As can be understood from FIG. 5, the common electrode 130 opposing the plurality of patch electrodes 122 has a plurality of slits 130a arranged parallel to one another. The direction in which the slits 130a extend is parallel to the direction in which the slits 122b extend. In other words, the common electrode 130 is composed of a plurality of electrodes arranged in a stripe form and electrically connected to one another.

The aspect ratio and the width of the slit 130a may also be the same as the aspect ratio and the width of the slit 122b of the corresponding patch electrode 122 and may be the same between the reflecting elements 120. In the common electrode 130, the plurality of slits 130a is also arranged at a constant spacing. Therefore, when the width of the slit 130a of the common electrode 130 is defined as a space width S₂ and the distance between adjacent slits 130a is defined as a line width L₂ (see FIG. 5), the line-space ratio (L₂/S₂), i.e., the ratio of the aforementioned distance to the width of the slit 130a, is constant within the common electrode 130. Furthermore, the line-space ratio (L₂/S₂) is also set to be relatively low and is equal to or greater than 0.05 and equal to or less than 4.0 or equal to or greater than 0.05 and equal to or less than 1.0. Therefore, the space width S₂ may be equal to or greater than the line width L₂. The aperture ratio of the common electrode 130 can be set in a wide range equal to or greater than 20% and equal to or less than 80% by setting L₂/S₂ in the above range, and a high aperture ratio reaching up to 80% can also be obtained depending on the setting value. Note that the number of slits 130a in the common electrode 130 may also be set according to the size of the common electrode 130 and the width of the slit 130a. The number of slits 130a is at least equal to or greater than 3 and is preferably 5 to 30 in each reflecting element 120. The difference in number between the slits 130a and the slits 122b is 0 or 1.

Similar to the patch electrode 122, the common electrode 130 may also be formed of a conductive oxide such as ITO or IZO or may contain a metal or alloy which can be used in the patch electrode 122. The common electrode 130 can also be fabricated by forming a film of a conductive oxide or a metal using a sputtering method or a CVD method and subsequentially processing this film by photolithography. When the common electrode 130 includes a metal, the metal film may be processed so that the portion between adjacent slits 130a has a mesh shape. Alternatively, the common electrode 130 may be formed using metal nanowires containing silver or gold. Not only can voltage drops associated with an increase in size of the intelligent reflecting surface 100 be prevented, but also the reflection angle of the incident radio waves can be controlled over a wider range by structuring the common electrode 130 so as to contain a 0-valent metal.

### (5) Orientation Film and Liquid Crystal Layer

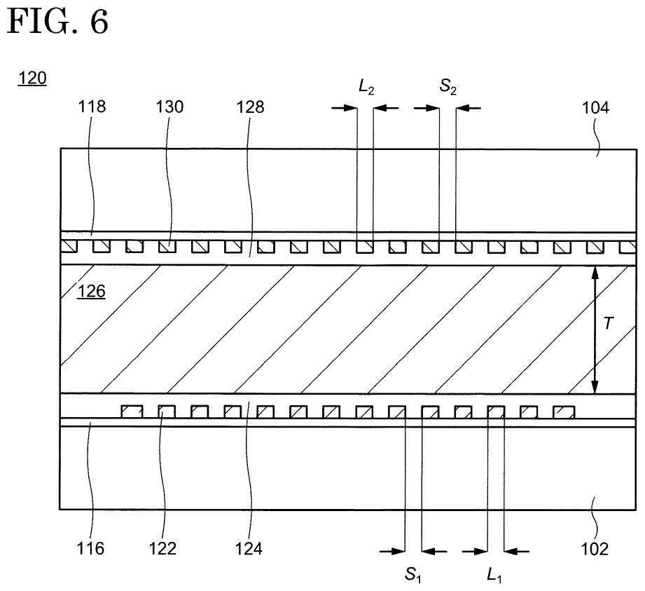

A schematic view of a cross section of the reflecting element 120 obtained along the chain line A-A′ in FIG. 4 is shown in FIG. 6. As shown in FIG. 6, the patch electrode 122 is provided over the substrate 102 directly or through an undercoat 116 which is an optional component. The undercoat 116 is composed of, for example, one or a plurality of films containing a silicon-containing inorganic compound such as silicon oxide and silicon nitride and is provided to prevent impurities contained in the substrate 102 from entering the liquid crystal layer 126. One of the pair of orientation films (hereinafter referred to as a first orientation film) 124 is provided over the patch electrode 122 so as to cover the patch electrode 122. Thus, the first orientation film 124 may be in contact with the substrate 102 or the undercoat 116. The first orientation film 124 is provided to control the orientation of the liquid crystal molecules structuring the liquid crystal layer 126 provided thereover. The first orientation film 124 may be provided continuously over the plurality of reflecting elements 120. In other words, the first orientation film 124 may be provided so as not to be divided between adjacent reflecting elements 120 and to be shared by all of the reflecting elements 120.

The first orientation film 124 includes a polymer such as a polyimide and a polyester. The first orientation film 124 is formed by utilizing a wet deposition method such as an ink-jet method, a spin-coating method, a printing method, and a dip-coating method, and a surface thereof is subjected to a rubbing process. Alternatively, the first orientation film 124 may be formed by a photo-alignment treatment.

The liquid crystal layer 126 contains liquid crystal molecules. The structure of the liquid crystal molecules is not limited. Thus, the liquid crystal molecules may be nematic liquid crystal, smectic crystal, cholesteric crystal, or chiral smectic liquid crystal. The thickness T of the liquid crystal layer 126 is, for example, equal to or greater than 20 μm and equal to or less than 100 μm or equal to or greater than 30 μm and equal to or less than 75 μm. Although not illustrated, spacers may be provided in the liquid crystal layer 126 to maintain this thickness throughout the intelligent reflecting surface 100. Note that, if the thickness of the liquid crystal layer 126 described above is employed in a liquid crystal display device, high responsiveness required to display moving images cannot be obtained, and it is significantly difficult to express the functions of a liquid crystal display device.

The common electrode 130 is provided to the counter substrate 104 either directly or through an overcoat 118 which is an optional component. Similar to the undercoat 116, the overcoat 118 may be composed of one or a plurality of films containing a silicon-containing inorganic compound such as silicon oxide and silicon nitride and is provided to prevent impurities contained in the opposite substrate 104 from entering the liquid crystal layer 126. Similar to the first orientation film 124, the other of the pair of orientation films (hereinafter referred to as a second orientation film) 128 is also provided to control the orientation of the liquid crystal molecules and covers the common electrode 130. The second orientation film 128 may also be formed to continue over adjacent reflecting elements 120 and to be shared by the plurality of reflecting elements 120. The first orientation film 124 and the second orientation film 128 are arranged so that the direction in which the first orientation film 124 orients the liquid crystal molecules is parallel to that of the second orientation film 128. The liquid crystal molecules are oriented in a certain direction by the first orientation film 124 and the second orientation film 128.

### (6) Arrangement of Patch Electrode and Common Electrode

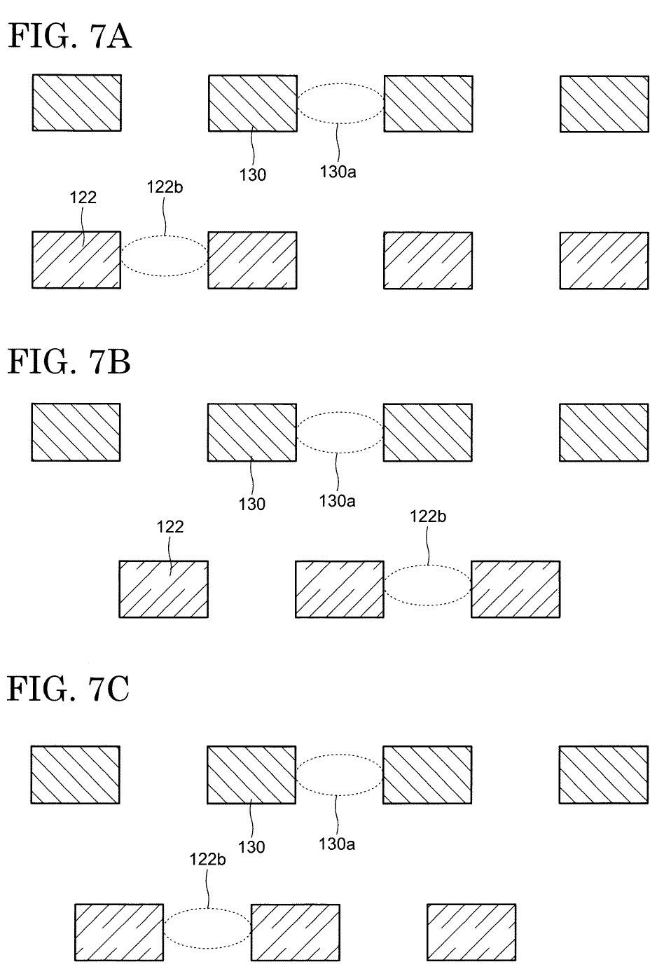

As described above, the slits 122b and the slits 130a with the same width are arranged at a constant spacing in the patch electrode 122 and the common electrode 130, respectively, and the width and the spacing of the slits 122b and the slits 130a are identical between the patch electrode 122 and the common electrode 130. Therefore, the patch electrode 122 and the common electrode 130 may be arranged so that all of the slits 122b and the slits 130a overlap each other in the vertical direction (normal direction of the substrate 102 or the counter substrate 104) as shown in the schematic cross-sectional view in FIG. 7A. However, the arrangement of the patch electrode 122 and the common electrode 130 is not limited thereto. For example, as shown in FIG. 7B, the patch electrode 122 and the common electrode 130 may be arranged so that at least one slit 122b of the patch electrode 122 overlaps in the vertical direction with a region between adjacent slits 130a of the common electrode 130, and similarly, at least one slit 130a of the common electrode 130 overlaps in the vertical direction with a region between adjacent slits 122b of the patch electrode 122. Alternatively, as shown in FIG. 7C, the patch electrode 122 and the common electrode 130 may be arranged so that at least one slit 122b of the patch electrode 122 overlaps in the vertical direction with the slit 130a and a region between adjacent slits 130a of the common electrode 130, and similarly, at least one slit 130a of the common electrode 130 overlaps in the vertical direction with the slit 122b and a region between adjacent slits 122b of the patch electrode 122. Since the light with an incident angle in a certain range is able to pass through the reflecting element 120 whichever arrangement is adopted, it is possible to ensure the light-transmitting property of the intelligent reflecting surface 100.

### 2. OPERATION OF INTELLIGENT REFLECTING SURFACE

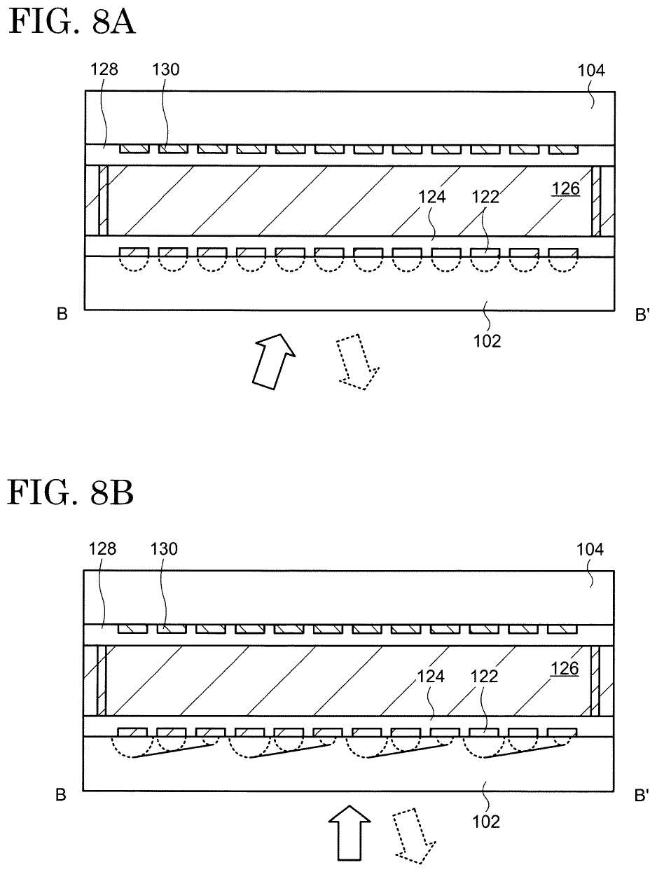

The operation of the intelligent reflecting surface is explained using schematic views of the cross section along the chain line B-B′ in FIG. 2 (FIG. 8A and FIG. 8B). In the intelligent reflecting surface 100 having the configuration described above, the directions in which the first orientation film 124 and the second orientation film 128 orient the liquid crystal molecules are the same. Hence, when no potential difference is applied between the patch electrode 122 and the common electrode 130, no vertical electric field is generated in the liquid crystal layer 126, and the liquid crystal molecules are splay-oriented. The orientation of the liquid crystal layer 126 is the same between the reflecting elements 120, and thus the dielectric constant is also constant within the liquid crystal layer 126. Therefore, as represented by the dotted arcs in FIG. 8A, the spread (phase) of the reflected radio waves generated when the radio waves (solid white arrow in FIG. 8A) incident from the patch electrode 122 side are reflected on the surface of the patch electrode 122 is the same between the reflecting elements 120. As a result, the incident radio waves are directly reflected by the intelligent reflecting surface 100, resulting in the reflected radio waves (dotted white arrow in FIG. 8A) with the same emission angle as the incident angle.

In contrast, when a potential difference is provided between the patch electrode 122 and the common electrode 130, the generated vertical electric field causes the liquid crystal molecules to rise and bend-orientate. When a vertical electric field of different intensity is generated between the reflecting elements 120, more specifically, between the rows or the columns in which the patch electrodes 122 are electrically connected, the dielectric constant of the liquid crystal layer 126 changes for each row or column according to the intensity of the vertical electric field. As a result, as shown by the dotted arcs in FIG. 8B, the phase of the reflected radio waves also changes for each row or column, by which the reflection direction of the incident radio waves (solid white arrow in FIG. 8B) can be in turn changed (see dotted white arrows in FIG. 8B). The reflection angle can be controlled by changing the intensity of the vertical electric field formed in the reflecting elements 120.

Here, both the substrate 102 and the counter substrate 104 are configured to transmit visible light in the intelligent reflecting surface 100 as described above. Furthermore, the patch electrode 122 and the common electrode 130 are formed to respectively have the slits 122b and 130a with a width allowing visible light to pass therethrough. Therefore, the intelligent reflecting surface 100 exhibits a light-transmitting property with respect to visible light no matter which of the arrangements shown in FIG. 7A through FIG. 7C is adopted. Furthermore, as demonstrated in the Example, high aperture ratio and excellent radio-wave reflection characteristics can be simultaneously established by adjusting the line-space ratios of the slits 122b and 130a (L₁/S₁, L₂/S₂) in the aforementioned ranges as appropriate, even if the patch electrode 122 and the common electrode 130 containing a metal are formed with a thickness sufficient to shield visible light. Hence, it is possible to provide an intelligent reflecting surface with high transmittance to visible light and excellent radio-wave reflection characteristics. Therefore, implementation of an embodiment of the present embodiment enables the production of an intelligent reflecting surface which does not spoil or significantly damage the landscape.

### 3. MODIFIED EXAMPLES

In the aforementioned intelligent reflecting surface 100, the change in the dielectric constant of the liquid crystal layer 126 is controlled row by row or column by column because the plurality of patch electrodes 122 in the same row or column is electrically connected. Therefore, although the reflection direction of radio waves can be changed, the change in the reflection direction is one-dimensional. In other words, incident radio waves are reflected at an angle rotated around an axis extending in the row direction or the column direction of the plurality of reflecting elements 120. However, the configuration of the intelligent reflecting surface 100 is not limited to the above configuration, and the potentials of the patch electrode 122 of the reflecting elements 120 may be individually controlled. This configuration allows the reflection direction to be two-dimensionally varied.

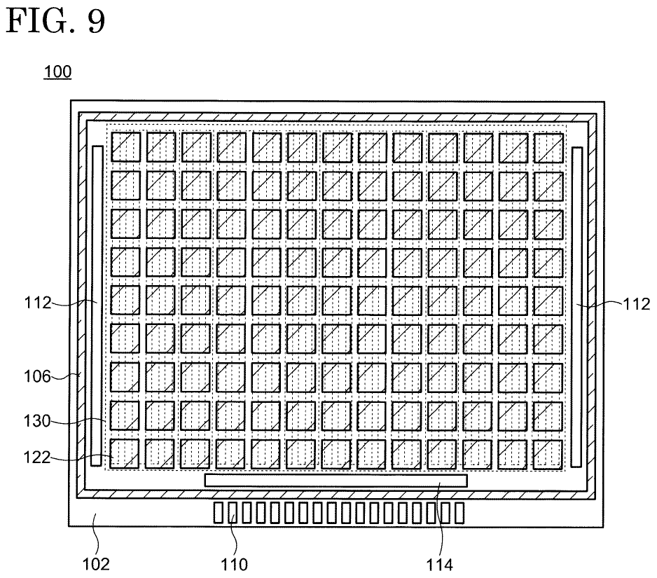

For example, the plurality of patch electrodes 122 is arranged in a matrix form so as to be electrically and physically independent from one another as shown in the schematic top view in FIG. 9, and an element circuit for controlling the patch electrodes 122 is formed in each reflecting element 120 as described below. A gate-line driver circuit 112 and a signal-line driver circuit 114 are formed over the substrate 102 to supply a variety of signals to the reflecting elements 120. The gate-line driver circuit 112 and the signal-line driver circuit 114 may be formed with insulating films, semiconductor films, and conductive films fabricated over the substrate 102 or by mounting, over the substrate 102, an integrated circuit prepared over a semiconductor substrate. The gate line drive circuit 112 may be one or more, and, in the latter case, two gate-line driver circuits 112 may be arranged over the substrate 102 so as to sandwich the plurality of reflecting elements 120 as shown in FIG. 9. The signal-line driver circuit 114 may be arranged on one side of the substrate 102 where the terminals 110 are formed.

A plurality of gate lines and a plurality of signal lines (not illustrated) respectively extend from the gate-line driver circuit 112 and the signal-line driver circuit 114 and are electrically connected to the reflecting elements 120. A variety of signals for driving the reflecting elements 120 is supplied through the plurality of terminals 110 to the gate-line driver circuit 112 and the signal-line driver circuit 114 from an external circuit which is not illustrated. The gate-line driver circuit 112 and the signal-line driver circuit 114 generate gate signals and control potentials on the basis of the supplied signals and supply them to the reflecting elements 120, thereby independently controlling the plurality of reflecting elements 120.

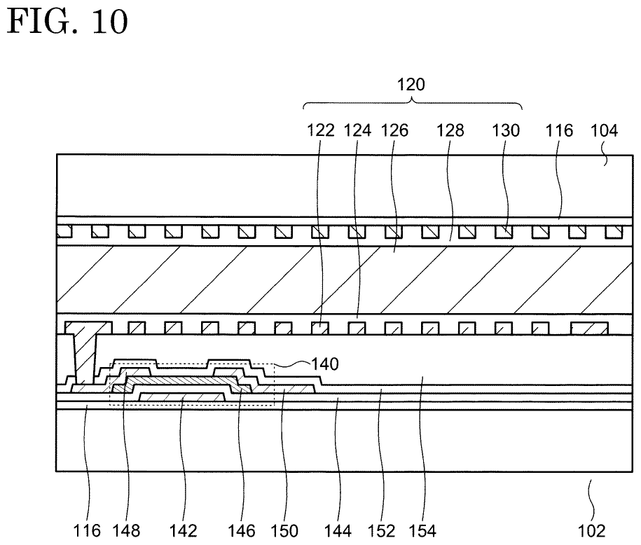

FIG. 10 shows a schematic cross-sectional view of one reflecting element 120. The element circuit is provided over the substrate 102 to control each reflecting element 120. The configuration of the element circuit may be determined arbitrarily, and one or a plurality of transistors, one or a plurality of capacitor elements, and the like may be combined as appropriate to form the element circuit. In the example shown in FIG. 10, one transistor 140 electrically connected to the patch electrode 122 of the reflecting element 120 is illustrated as one of the components of the element circuit.

As can be understood from FIG. 10, the element circuit is provided over the substrate 102 either directly or through the undercoat 116 which is an optional component. There are no restrictions on the structure of the transistors included in the element circuit, and either or both bottom-gate type and top-gate type transistors may be used. Alternatively, the transistor may be a transistor with gate electrodes over and under a semiconductor film. The transistor 140 exemplified in FIG. 10 is a bottom-gate type transistor and is composed of a gate electrode 142, a gate insulating film 144 over the gate electrode 142, a semiconductor film 146 over the gate insulating film 144, and a pair of terminals 148 and 150 over the semiconductor film 146. A leveling film 154 is provided over the transistor 140, over which the reflecting element 120 is fabricated. As an optional component, an interlayer insulating film 152 may be provided between the transistor 140 and the leveling film 154.

The gate electrode 142, the gate insulating film 144, the semiconductor film 146, the terminals 148, 150 as well as the interlayer insulating film 152 and the leveling film 154 covering the transistor 140 may be formed by using known materials and applying known methods as appropriate. Therefore, a detailed explanation is omitted. In brief, the gate electrode 142 and the terminals 148 and 150 are formed by forming a film containing a metal such as tantalum, molybdenum, titanium, and aluminum using a sputtering method or a CVD method, followed by appropriately patterning this film by photolithography processes. The semiconductor film 146 is formed as a film containing a Group 14 element exemplified by silicon or an oxide of a Group 13 element such as indium and gallium. The semiconductor film 146 may also be formed by applying a sputtering method or a CVD method. The gate insulating film 144 and the interlayer insulating film 152 include a silicon-containing inorganic compound such as silicon oxide and silicon nitride and are formed by applying a sputtering method or a CVD method. The leveling film 154 includes a polymer such as an acrylic resin, an epoxy resin, a polyimide, a polyamide, and a silicon resin and may be formed using a wet film-forming method such as a spin coating method, an inkjet method, and a printing method as appropriate. The formation of the leveling film 154 allows the reflecting element 120 to be formed on a flat surface. The patch electrode 122 is electrically connected to the transistor 140 through an opening formed in the interlayer insulating film 152 and the leveling film 154, whereby a control potential is supplied from the signal-line driver circuit 114 to the reflecting element 120.

As described above, the potential of the patch electrodes 122 of the plurality of reflecting elements 120 can be individually controlled by using element circuits in the intelligent reflecting surface 100 according to this modified example. Therefore, the dielectric constants of the liquid crystal layer 126 of the plurality of reflecting elements 120 are also individually controlled. As a result, the phase change of the reflected radio waves can also be controlled for each of the reflecting elements 120, and the reflection direction of radio waves can be two-dimensionally controlled. That is, the incident radio waves can be reflected at an angle rotated around two axes extending in the column direction and the row direction of the plurality of reflecting elements 120.

### EXAMPLES

In this example, the results of a simulation study of the effects of the widths of the slits 122b and 130a of the patch electrode 122 and the common electrode 130 structuring the reflecting element 120 on the radio-wave reflection characteristics are explained.

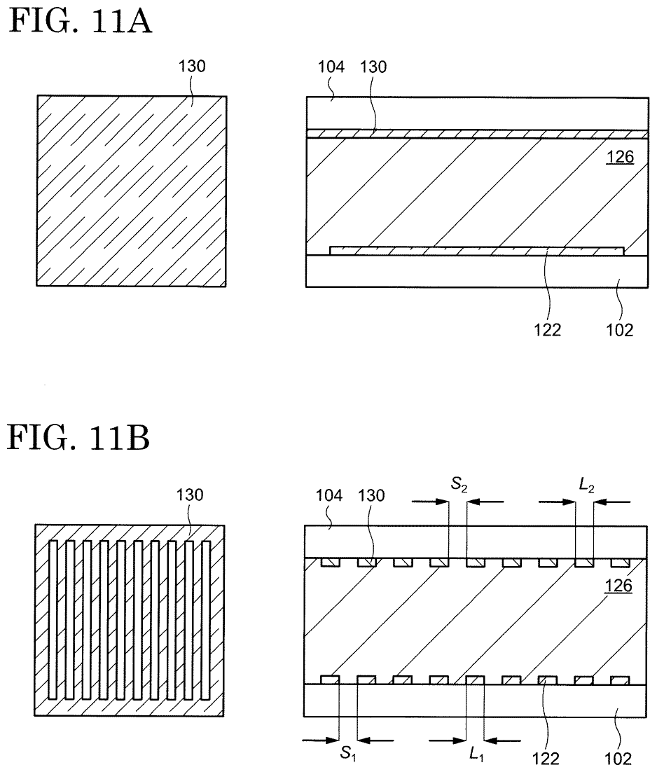

Schematic views of the evaluated model element 1 are shown in FIG. 11A, and schematic views of the model elements 2 to 4 are shown in FIG. 11B. In each of FIG. 11A and FIG. 11B, the drawing on the left side is a schematic top view, while the drawing on the right side is a schematic cross-sectional view. In the model elements 1 to 4, a square patch electrode 122 (2.8 cm×2.8 cm), a square common electrode 130 (3.7 cm×3.7 cm), and a liquid crystal layer 126 sandwiched therebetween were set. The electrical conductivity and the relative permittivity of the patch electrode 122 and the common electrode 130 were set to be 3.5×10⁷ S/m and 5.4, respectively, the relative permittivity of the liquid crystal layer 126 was varied between 2.5 and 3.5, and the thickness of the liquid crystal layer 126 was set to be 40 μm. In the model element 1, the patch electrode 122 and the common electrode 130 without any slits were set. On the other hand, the slits 122b and 130a having the same width and overlapping each other were respectively set on the patch electrode 122 and the common electrode 130 in the model elements 2 to 4. The widths of the slits 122b and 130a (space widths S₁ and S₂) and the distances between adjacent slits 122b and between adjacent slits 130a (line widths L₁ and L₂) are shown in Table 1 below. From Table 1, it can be understood that the line-space ratio of the model elements 2 to 4 are each 1, and thus the aperture ratios of these model elements are each 50%. On the other hand, the aperture ratio of the model element 1 is 0%.

TABLE 1
Structure of patch electrode and common
electrode of model elements 2 to 4.

| | Space width | Space width | Line width | Line width |
|---|---|---|---|---|
| Model | S₁ | S₂ | L₁ | L₂ |
| element | (μm) | (μm) | (μm) | (μm) |
| 2 | 20 | 20 | 20 | 20 |
| 3 | 67 | 67 | 67 | 67 |
| 4 | 175 | 175 | 175 | 175 |

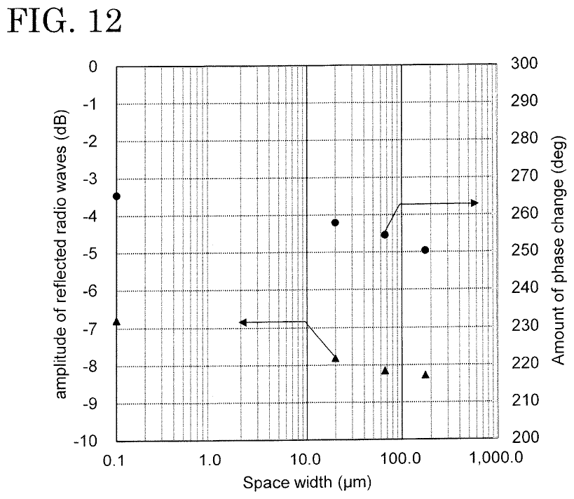

The simulation results are shown in FIG. 12. The left vertical axis of the graph shown in FIG. 12 represents the attenuation of the amplitude of the reflected radio waves in normal logarithm and reveals that a decrease in value means a stronger absorption of radio waves, i.e., a decrease in reflectance. The right vertical axis in FIG. 12 represents the amount of phase change of the incident radio waves, and a larger phase change means that the reflection angle is larger than the incident angle. That is, a larger right vertical axis means that the reflection angle can be more largely changed. In both plots, the leftmost points are the simulation results of the model element 1.

As can be understood from the results in FIG. 12, although the reflectivity and the amount of phase change decrease as the space widths of the slits 122b and 130a increase, it is possible to ensure high reflectance and a phase change comparable to those of the model element 1 without any slits by setting the widths of the slits 122b and 130a to be smaller than a certain value. The results in FIG. 12 suggest that when the line-space ratio L₁/S₁ and L₂/S₂ are 1, a high aperture ratio and excellent radio-wave reflection characteristics can be achieved if the widths of slits 122b and 130a are equal to or less than 30 μm.

As described above, it is possible to provide an intelligent reflecting surface capable of simultaneously having a high aperture ratio and excellent radio-wave reflection characteristics by setting L₁/S₁ and L₂/S₂ to be relatively low and adjusting the widths of the slits 122b and 130a (i.e., space widths S₁ and S₂) to be relatively small. Therefore, implementation of an embodiment of the present invention enables the production of a light-transmitting intelligent reflecting surface which does not detract the landscape.

The aforementioned modes described as the embodiments of the present invention can be implemented by appropriately combining with each other as long as no contradiction is caused. Furthermore, any mode which is realized by persons ordinarily skilled in the art through the appropriate addition, deletion, or design change of elements or through the addition, deletion, or condition change of a process on the basis of the reflecting element and intelligent reflecting surface according to each embodiment is included in the scope of the present invention as long as they possess the concept of the present invention.

It is understood that another effect different from that provided by each of the aforementioned embodiments is achieved by the present invention if the effect is obvious from the description in the specification or readily conceived by persons ordinarily skilled in the art.

What is claimed is:

1. An intelligent reflecting surface comprising a plurality of reflecting elements arranged in a matrix form having a plurality of rows and a plurality of columns, the plurality of reflecting elements each comprising:
a patch electrode having a plurality of first slits extending in one of a row direction and a column direction;
a first orientation film over the patch electrode;
a liquid crystal layer over the first orientation film;
a second orientation film over the liquid crystal layer; and
a common electrode located over the second orientation film and having a plurality of second slits,
wherein the plurality of first slits has the same width as one another and is parallel to one another,
the plurality of second slits is each parallel to the plurality of first slits and has the same width as the plurality of first slits, and
in each of the plurality of reflecting elements, a distance between adjacent first slits is constant and the same as a distance between adjacent second slits.

2. The intelligent reflecting surface according to claim 1,
wherein, in each of the plurality of reflecting elements, a ratio of the distance between adjacent first slits with respect to the width of the first slits is equal to or greater than 0.05 and equal to or less than 4.0.

3. The intelligent reflecting surface according to claim 1,
wherein, in each of the plurality of reflecting elements, a ratio of the distance between adjacent first slits with respect to the width of the first slits is equal to or greater than 0.05 and equal to or less than 1.0.

4. The intelligent reflecting surface according to claim 1,
wherein the width of the plurality of first slits is equal to or greater than 0.1 μm and equal to or less than 30 μm.

5. The intelligent reflecting surface according to claim 1,
wherein the width of the plurality of first slits is equal to or greater than a distance between adjacent first slits.

6. The intelligent reflecting surface according to claim 1,
wherein the patch electrodes located in the same column are electrically connected to one another.

7. The intelligent reflecting surface according to claim 1,
wherein the patch electrodes located in the same row are electrically connected to one another.

8. The intelligent reflecting surface according to claim 1,
wherein each of the plurality of reflecting elements further comprises a transistor electrically connected to the patch electrode.

9. The intelligent reflecting surface according to claim 1,
wherein the common electrodes located in the same column are electrically connected to one another.

10. The intelligent reflecting surface according to claim 1,
wherein the common electrodes located in the same row are electrically connected to one another.

11. The intelligent reflecting surface according to claim 1,
wherein all of the common electrodes of the plurality of reflecting elements are electrically connected to one another.

12. The intelligent reflecting surface according to claim 1,
wherein the patch electrode and the common electrode each include a 0-valent metal.

13. The intelligent reflecting surface according to claim 1,
wherein the plurality of first slits overlaps the plurality of second slits in a plan view.

14. The intelligent reflecting surface according to claim 1,
wherein at least one of the plurality of first slits overlaps a region between adjacent second slits in a plan view.

15. The intelligent reflecting surface according to claim 1,
wherein at least one of the plurality of first slits overlaps the second slit and a region between adjacent second slits in a plan view.
